(19) United States
(12) Patent Application Publication
(10) Pub. No.: US 2009/0177480 A1
(43) Pub. Date: Jul. 9, 2009

(54) System And Method For Identifying Targeted Consumers Using Partial Social Security Numbers

(75) Inventors: Wenhan Chen, Roslyn Heights, NY (US); John Clements, East Meadow, NY (US); Di W. Xu, Edison, NJ (US); Chao Yuan, Montclair, NJ (US); Wenbiao Zhao, Jersey City, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/970,356

(22) Filed: Jan. 7, 2008

(51) Int. Cl. G06Q 99/00

(52) U.S. Cl. 705/1

(57) ABSTRACT

A system and method are used to identify a targeted consumer. The system includes a partial social security number (SSN) system that identifies a partial SSN issued during a preselected time period and a marketing database system. The marketing database system receives a comparison result from a SSN matching system that identifies at least one individual in a consumer database having a partial SSN that matches the partial SSN identified by the partial SSN system. The marketing database system places identifying information of the at least one individual in a marketing database. In one method, an individual is identified as a targeted consumer based on the individual's age being within a preselected age range and the individual's social security number being issued within a predetermined social security number SSN issue date range. Identifying information of the targeted consumer is stored in a contact database, which a business may use to directly market its goods or services.

### BACKGROUND OF THE INVENTION

1. Field Of The Invention

The present invention generally relates to systems and methods for identifying consumer populations, and more particularly to systems and methods for identifying consumers having at least one common characteristic that potentially make them desirable targets for directing marketing efforts.

2. Related Art

Direct marketing has become one of the major marketing channels used today. Depending on the product or service being marketed, it may be desirable to market to a particular group of consumers who are considered to be more likely interested in the product or service than the world of consumers generally. For example, for marketing golf equipment or resorts with golf courses, targeting those consumers who have taken up golf as a sport may be a more fruitful effort than targeting all consumers regardless of their interest in golf. Similarly, with a product or service involving credit cards, or other financial transaction instruments, and issuance thereof to consumers, it may be desirable to target those consumers reaching or approaching adulthood or otherwise emerging as a consumer, and therefore potentially interested in acquiring a credit card. A particular group of emerging consumers is new immigrants or resident aliens living and working in the United States. It has been very challenging to effectively identify this group of emerging consumers for focusing direct marketing efforts to promote products or services. Such emerging consumers may be more receptive to direct mailings or other marketing efforts as they are introduced to the products and services existing in the marketplace. Further, emerging consumers generally are unlikely to have acquired brand loyalties and offer to businesses a “clean slate” for accepting their brands and hopefully building consumers' brand loyalty. In order to build a mailing list with a high concentration of new immigrants, some marketers have tried to use the ethnic origins of last names as a method for identifying new immigrants.

Given the foregoing, what is needed is a system and method for identifying targeted consumers, especially in the instance in which the targeted consumers are a population of new immigrant and resident aliens. The targeted consumers may then receive marketing materials, for example, or may otherwise be deemed eligible to receive a product or service.

### SUMMARY OF THE INVENTION

The present invention meets the above-identified needs by providing a system, method and computer program product for identifying targeted consumers using partial social security numbers (SSNs) and ages of consumers.

One embodiment of the present invention provides a method having the following steps: an individual is identified as a targeted consumer at least based on whether the individual's age is within a preselected age range and the individual's social security number was issued within a predetermined social security number (SSN) issue date range. If the individual is identified as a targeted consumer, then identifying information of the targeted consumer is stored in a contact database.

In another embodiment, a method includes the following steps: a SSN issue date range for a potential targeted consumer is received; the potential targeted consumer is identified as a targeted consumer at least based on the age of the potential targeted consumer and the targeted consumer's SSN issue date range; and if the potential targeted consumer is identified as a targeted consumer, then identifying information of the targeted consumer is placed on a contact list stored in a contact database. In one embodiment, the potential targeted consumer is a consumer listed in a credit bureau database that is composed substantially of consumers having an age of 18 years and over, and the potential targeted consumer is identified as a targeted consumer when the SSN issue date range of the potential targeted consumer includes a time period within the previous year to the previous five years. In this instance, the targeted consumer is likely an immigrant or a resident alien. That is, if a person is at or above 18 years old, and has recently obtained a new SSN, the person may be identified as an immigrant or resident alien.

In another embodiment, a method includes the following steps: a group of potential targeted consumers is selected; an issue date range for a partial SSN of each potential targeted consumer in the group is identified; each potential targeted consumer's birth date in the group is identified; the birth date with the SSN issue date range of each potential targeted consumer is compared; each potential targeted consumer having a birth date that precedes the targeted consumer's SSN issue date range by a preselected time period is selected as the targeted consumer; and identifying information of the targeted consumer is stored in a contact database.

One embodiment of the present invention provides a system including a partial SSN system and a marketing database system. The partial SSN system identifies a partial SSN issued during a preselected time period. The marketing database system receives a comparison result from a SSN matching system that identifies at least one individual in a consumer database having a partial SSN that matches the partial SSN identified by the partial SSN system. The marketing database system places identifying information of the at least one individual in a marketing database.

Another embodiment of a system presented herein includes a SSN issue date system and a marketing database system. The SSN issue date system receives a result from a SSN matching system of at least one individual in a consumer database and the individual's respective SSN issue date range. The consumer database is composed substantially of consumers having an age within a preselected age range. The SSN issue date system identifies those at least one individual that has a SSN issue date range that is during a preselected time period. The marketing database system receives the at least one individual identified by the SSN issue date system and places identifying information of of the at least one identified individual in a marketing database.

An advantage of the present invention is that it may be used to identify targeted consumers based on a correlation of partial SSNs and age, and can be used to identify emerging consumers, in particular new U.S. immigrants and/or resident aliens.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram of an example system according to an embodiment of the present invention.

FIG. 2 is a block diagram of an example system according to another embodiment of the present invention.

FIG. 3 is a flowchart illustrating a process for identifying a targeted consumer according to one embodiment of the present invention.

FIG. 4 is a flowchart illustrating a method for identifying an individual as a targeted consumer in a step of the process shown in FIG. 3, according to one embodiment of the present invention.

FIG. 5 is a flowchart illustrating a process for identifying a targeted consumer according to another embodiment of the present invention.

FIG. 6 is a block diagram of an exemplary computer system useful for implementing the present invention.

### DETAILED DESCRIPTION

### I. Overview

A system, method and computer program product is described for identifying a targeted consumer, whereby a marketing database may be populated with such targeted consumers so that marketing efforts may be focused on these consumers.

The present invention is now described in more detail herein in terms of the above exemplary description. This is for convenience only and is not intended to limit the application of the present invention. In fact, after reading the following description, it will be apparent to one skilled in the relevant art(s) how to implement the following invention in alternative embodiments.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Financial transaction instruments may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

### II. System

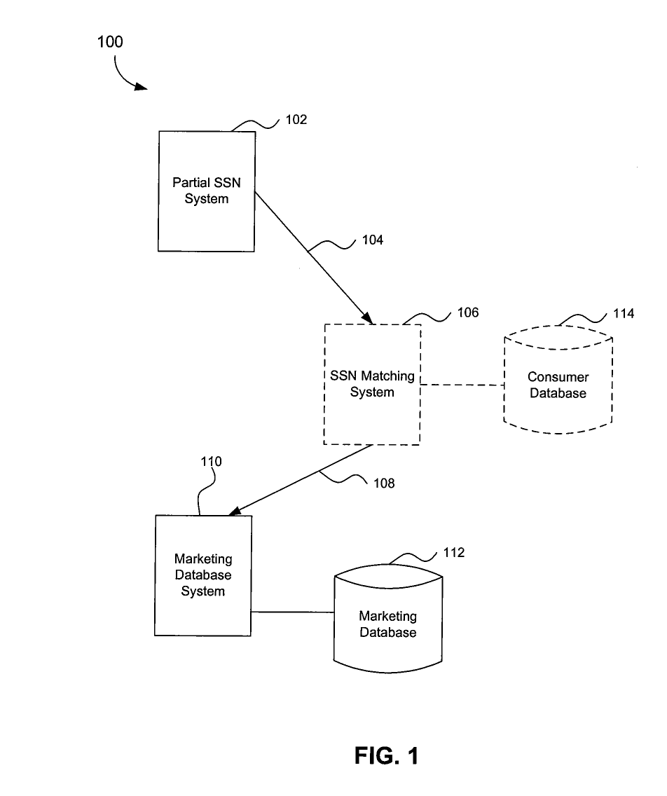

Referring to FIG. 1, a system diagram of an exemplary system 100 in which the present invention, in an embodiment, would be implemented, is shown. System 100 includes a partial social security number (SSN) system 102 and a marketing database system 110, which includes a marketing database 112. System 100 may be used, for example, for direct marketing purposes to identify a targeted consumer. Typically, a consumer may be targeted by a business when the business desires to send marketing materials on a product or service to that consumer. The consumer can be a potential new consumer of the product or service, or the consumer can be an existing or prior consumer of the product or service. Moreover, the business may seek to provide marketing materials to an existing consumer relating to a product or service provided by a third party business. For example, a credit card issuer may desire to target its existing card holding customers to provide them with marketing materials on restaurants or merchandise retailers in their neighborhood. Since newcomers to the neighborhood may be more receptive to marketing materials highlighting local businesses, system 100, and the other embodiments of the present invention described herein, may be used to identify such newcomers. System 100, and the other embodiments of the present invention described herein, may also be used to screen solicitations from consumers, such as consumers' applications for the product or service (e.g., a credit card or loan application to allow the business to target only those consumers that the business considers eligible for the product or service (e.g., creditworthy consumers whose credit card or loan application is accepted).

In the embodiment shown in FIG. 1, at least one partial SSNs 104 are identified by partial SSN system 102 and provided to a SSN matching system 106. SSN matching system 106 provides a comparison result 108, which is an identification of at least one individual having a partial SSN 104. For instance, SSN matching system 106 may be offered by a third party marketing vendor owning, or otherwise having rights to, consumer database 114. Consumer database 114 may be any resource of identifying information (e.g., name, address, email address, telephone number, etc.) of individual(s) and includes at least partial SSN(s) of the individual(s) so as to allow comparison with partial SSN(s) 104. The third party marketing vendor may provide as a service the identification of at least one individual that match a given criteria. In this instance, the criteria is at least one partial SSN 104 issued during a preselected time period. For example, SSN matching system 106 may be a service offered by the credit bureau or agency (e.g., TransUnion LLC of Chicago, Ill., Equifax Inc. of Atlanta, Ga. and Experian Americas of Costa Mesa, Calif., or a future-established agency or bureau) having consumer database 114. In this instance, consumer database 114 may also be a resource of credit history information on the individuals. System 100 may or may not include SSN matching system 106, and may or may not include associated consumer database 114.

The comparison result 108 from SSN matching system 106 is received by marketing database system 110, which places identifying information of the at least one individual in marketing database 112. Marketing database 112 may then be used, for example, to construct a direct marketing roster (e.g., a direct mailing list or telemarketing phone list) of those individuals identified by system 100. A business having rights to the direct marketing roster may then provide these identified individuals for providing promotional materials of the business. For a business promoting a product or service involving credit cards or other financial transaction instruments, or providing loans, for example, the business may further screen the direct marketing roster so as to only target those individuals that the business deems creditworthy. Alternatively, marketing database system 110 may be configured to screen comparison result 108 so as to select at least one individual based on a measure of creditworthiness and place only the selected individual(s) in marketing database 112.

Where marketing efforts are targeted to a population of emerging consumers, system 100 may be configured to identify these emerging consumers. In an embodiment, system 100 identifies targeted consumers based on a correlation of partial SSNs and age, and can be used to identify individuals having recently issued SSNs that are of spending age. Moreover, system 100 may be used to identify those consumers just entering the marketplace in the United States and thus providing businesses a clean slate for promoting their goods or services and building brand loyalty. For example, system 100 may be configured to identify new immigrants and resident aliens in adulthood. Assuming new immigrants and resident aliens have recently obtained SSNs and assuming that a majority of native born U.S. citizens obtain a SSN at or near birth or during early adolescence, the fact that the new immigrant or resident alien obtained his or her SSN during or near adulthood may be used as an identifying characteristic of this emerging consumer population. That is, if a person is at or above 18 years old, and has recently obtained a new SSN, the person may be identified as an immigrant or resident alien. Thus, to capture SSNs issued recently, such as in the previous two years, for example, partial SSN system 102 may be configured to identify those partial SSNs that were issued in this preselected time period (e.g., the previous two years).

If consumer database 114 is substantially composed of consumers in the age of adulthood, that is, ages 18 or over, the identified individuals are assumed to be new immigrants or resident aliens by reason of their recently issued SSN. For example, a credit bureau database or a database of customers subscribing to a service which is geared toward persons in their adulthood may be by default substantially composed of consumers ages 18 and over. For example, consumer database 114 may be a list of subscribers to a newspaper or magazine directed to adult readers. Thus, the assumed age range of the consumers of consumer database 114 is used as a proxy for knowing the actual consumer's age. As such, the partial SSNs identified by partial SSN system 102 may target recently issued SSNs, and SSN matching system 106 provides comparison result 108 of individuals that are unlikely to be newborns and instead new immigrants or resident aliens. In one embodiment, consumer database 114 is a database of existing or prior consumers of a business, whereby comparison result 108 from SSN matching system 106 may be used by the business to identify new immigrants or resident aliens for the purpose of providing them with marketing materials relating to products and services offered by third party businesses in their neighborhood. As noted above, new immigrants or resident aliens, as newcomers to a neighborhood, may be more receptive and interested in receiving such marketing materials.

Marketing database system 110 then receives comparison result 108 from SSN matching system 106 and adds these identified individual(s) in its marketing database 112. Marketing database 112 thus may be composed of new immigrants and resident aliens. While marketing database 112 may also be composed of other consumers that recently obtained their SSN by one reason or another, exemplary system 100 still may identify a substantial number of new immigrants and resident aliens, without resorting to traditional methods of using ethnic origins of last names as an identifying factor for this group of emerging consumers.

For a business promoting a product or service involving financial transaction instruments or loans, for example, the business may wish to target only those new immigrants and resident aliens that meet the business' standard of creditworthiness. Therefore, as noted above, marketing database system 110 may be configured to screen comparison result 108 so as to select individual(s) based on a measure of creditworthiness and place only the selected individuals in marketing database 112.

For example, system 100 may be used to identify an individual as a targeted consumer based on a measure of the individual's creditworthiness and whether the individual's social security number was issued during a time period when the individual's age was 18 years of age and over, whereby the targeted consumer is likely an immigrant or a resident alien. In this instance, comparison result 108 may be composed of at least one individual having a social security number issued when the individual was 18 years of age or over. Marketing database system 110 may then screen comparison result 108 to select only those individuals that are considered creditworthy.

Creditworthiness may be measured by conventional methods such as credit history and credit score. Oftentimes, where the targeted consumer is a new immigrant or resident alien, no significant credit history is available to allow the business to judge the credit risk associated with extending credit to the individual. Therefore, other measures of creditworthiness may be used, including the individual's zip code, value of a home owned by the individual or equity in the home, or any combination thereof. Assumptions may be made on demographics based on the individual's zip code, thereby allowing estimation of the individual's income. Home value can be determined based on property tax records and knowing the name and address of the individual.

Partial SSN system 102 may employ a SSN issue date range database to identify partial SSNs issued during the preselected time period. In the United States, the SSN issue date range is available publicly. A SSN issue date range database may be acquired from a third party vendor or developed using U.S. government published data on SSN issuance. The SSN issue date range provides a time period, or date range, during which a SSN was issued by a given U.S. state. For example, an issue date range database may include issue date ranges for each distinct first 5 digits of a SSN from any period of history and up to present day, for one or more U.S. states. Typically, in a given U.S. state in which a SSN is issued, a SSN has a 1^{st}, 2^{nd}, and 3^{rd} digit (reading from left to right), sometimes referred to as a SSN “area code”, which identifies the issuing U.S. state, and has a characteristic 4th & 5th digit, sometimes referred to as a SSN “group number.” The last 4 digits of a SSN are usually issued in numerical order. U.S. states are referred to herein to include any SSN issuing government authority, including U.S. territories to the extent they have distinct SSN area codes. The given U.S. state issues SSNs over a time period using a particular group number before changing to a new group number, such as when, for a given group number, the iterations of the last 4 digits have been exhausted in issued SSNs. The time period over which a given group number is used establishes an issue date range for a SSN having that group number and issued by that particular U.S. state. The date when a given U.S. state starts to use a particular group number is public record, and therefore a SSN issue date range database may be developed knowing the start date (and consequently the end date) of the use of group numbers and the SSN area codes corresponding to the U.S. states. Such a database corresponds the first 5 digits of a SSN with its associated the issue date range.

For each U.S. state, partial SSN system 102 identifies a different partial SSN issued during the preselected time period. Moreover, if the preselected time period extends over a date range in which a given U.S. state has used more than one group number, it is feasible that partial SSN 102 identifies a plurality of partial SSNs for a given state during the preselected time period. SSN matching system 106 is able to identify individuals in its consumer database 114 having these partial SSNs identified by partial SSN system 102.

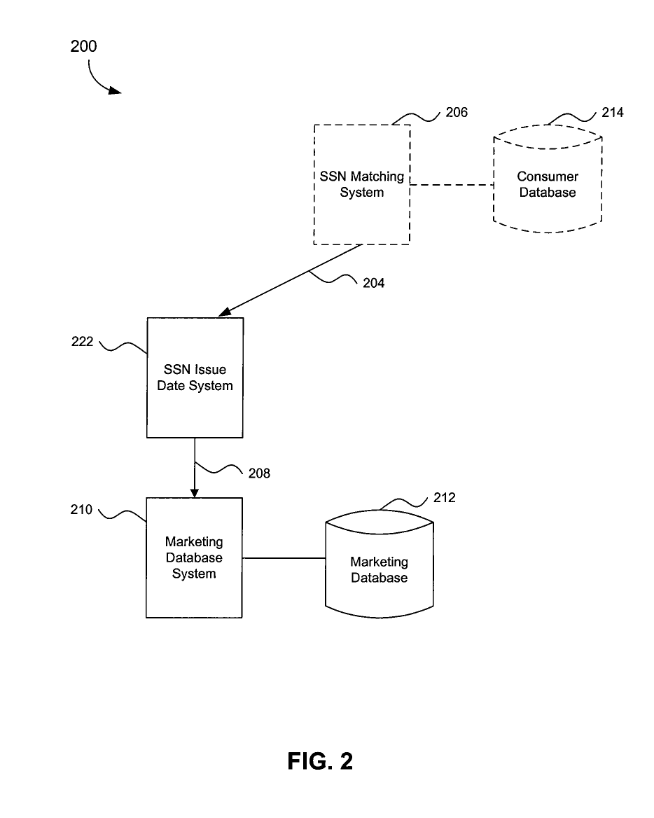

Referring to FIG. 2, a system diagram of an exemplary system 200 in which the present invention, in another embodiment, may be implemented, is shown. System 200 includes a SSN issue date system 222 and a marketing database system 210, which includes a marketing database 212. SSN issue date system 222 receives a result 204 from a SSN matching system 206 of at least one individual in a consumer database 214 and the individual's respective SSN issue date range. Consumer database 214 is composed substantially of consumers having an age within a preselected age range, and may also be a resource of credit history information on the individuals. Consumer database 214 includes partial SSNs of the individuals and/or their SSN issue date range. If only partial SSNs are included in the consumer database, SSN matching system 206 may employ a SSN issue date range database (not shown) to identify the SSN issue date range of each individual identified in result 204. Similar to system 100, system 200 may or may not include SSN matching system 206, and may or may not include associated consumer database 214.

The SSN issue date system 222 identifies those at least one individual in result 204 that has a SSN issue date range that is during a preselected time period. Marketing database system 210 receives a comparison result 208 of the at least one individual identified by SSN issue date system 222 and places identifying information of the at least one of the identified individual in marketing database 212. In one embodiment, the preselected time period is a time period within the previous one to five years, and the preselected age range is ages 18 years and over. As such, comparison result 208 is likely substantially composed of immigrants or resident aliens just entering (i.e., within the previous 5 years) the United States market place. Like marketing database system 110 of system 100, marketing database system 210 may be configured to select at least one individual of comparison result 208 that is considered creditworthy based on a measure of creditworthiness, wherein only the selected individuals are placed in the marketing database.

In one embodiment, system 200 is used by a business to identify targeted consumers in which the targeted consumer is an individual that has submitted a credit card or loan application that is accepted by the business. The business accepts the application because the individual is determined to be a new immigrant or resident alien of spending age. The business makes this determination based on the assumption that such an individual presents a lower credit risk for the extension of credit (i.e., creditworthiness) by the business. In this embodiment, the consumer database 214 represents a repository of credit card or loan applications submitted by individuals, along with any credit history information on the individuals, and marketing database 212 represents a repository of those applications which were accepted. At least one individual in consumer database 214 is identified in result 204, which includes each individual's SSN issue date range as provided by SSN matching system 206 and any credit history information. SSN issue date system 222 identifies at least one individual in result 204 that has a SSN issue date range during a time period when the individual's age is 18 years of age and over, such that the individual is considered to be an immigrant or resident alien, and provides the selected individual(s) as comparison result 208. In one embodiment, SSN issue date system 222 identifies the at least one individual age 18 years and over that has a SSN issue date range during a recent time period (e.g., within the previous two years), such that the individual is considered to be an immigrant or resident alien just entering the U.S. marketplace. The business may accept credit card or loan applications of those selected individuals and place them in marketing database 212. In one embodiment, marketing database system 210 screens individuals of comparison result 208 based on a measure of creditworthiness (e.g., home address demographic assumptions) and identify those individuals that have a credit risk level acceptable to the business. The business may then accept credit card or loan applications of only those identified individuals that are not only considered to be new immigrants or resident aliens, but also considered creditworthy.

### III. Process

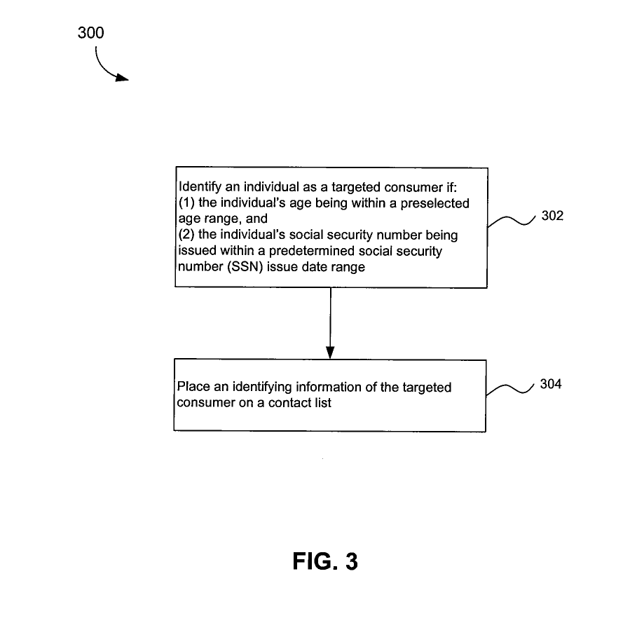

In accordance with the present invention, an individual is identified as a targeted consumer based on the age and the SSN issue date range of the individual. Referring to FIG. 3, a flowchart illustrating a process 300 for identifying a targeted consumer, according to one embodiment of the present invention, is shown. Process 300 begins at step 302, at which an individual is identified as a targeted consumer if the individual's age is in a preselected age range and the individual's SSN was issued within a predetermined SSN issue date range. If the individual meets the preselected age range and the predetermined SSN issue date range criteria, then in step 304, identifying information of this individual is placed on a contact list. The contact list may then be used as a direct mailing list or telemarketing phone list, for example, as part of direct marketing efforts to promote a product or service.

In one embodiment, the individual is the target consumer if the individual's SSN is issued during a time period when the individual's age is within the preselected age range. For example, the preselected age range may be ages 18 and over, and therefore this selected age range targets consumers in adulthood. If the individual's SSN is issued when the individual is age 18 or over, the individual may more likely be an immigrant or resident alien, and as such, process 300 may be used to target this group of emerging consumers. In another embodiment, process 300 identifies emerging consumers based on a correlation of recently issued SSNs and age. In this instance, the preselected age range is chosen to be 18 years of age or older, and the predetermined SSN issue date range corresponds to a group of SSNs issued in a given U.S. state within the previous year and having the common 4th and 5th digit. As described above, for a given U.S. state, the 4th and 5th digit of a SSN corresponds to the characteristic group number for the given U.S. state. It should be apparent that the predetermined SSN issue date range may also correspond to a second group of SSNs issued in a second U.S. state within the previous year, and so on for each U.S. state. If the individual is age 18 or over (i.e., has an age within the chosen preselected age range) and has a recently issued SSN (i.e., has a SSN having a 4th and 5th digit in common with the group of SSNs corresponding to the predetermined issue date range,) then the individual is identified as a target customer. Such identified individuals are those emerging consumers that are more likely to be immigrants or resident aliens just entering (i.e., within the previous year) the United States market place.

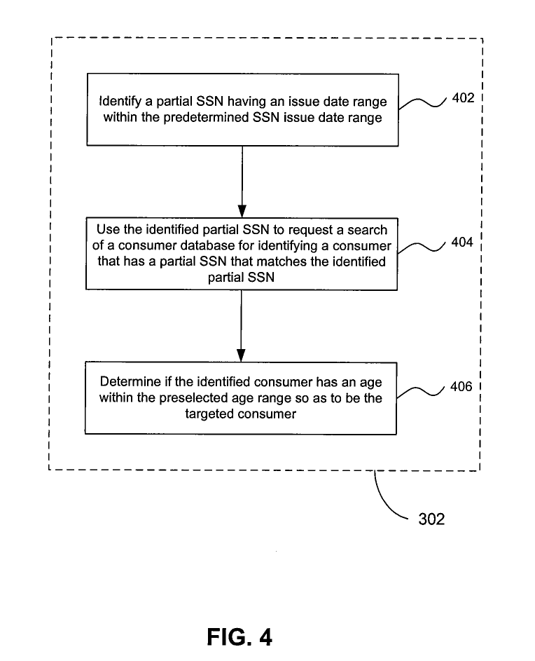

An exemplary process for identifying an individual as a targeted consumer in step 302 is illustrated in FIG. 4. As shown, identifying step 302 may include step 402 in which a partial SSN having an issue date range within the predetermined SSN issue date range is identified. In step 404, this identified partial SSN is used to request a search of a consumer database (e.g., a credit bureau database) for identifying a consumer that has a partial SSN that matches the identified partial SSN. In step 406, the identified consumer(s) are determined to be the targeted consumers if they have an age within the preselected age range. For example, in addition to partial SSN information for each individual in the consumer database, the database might also include an age or age range of the individual, or other data for projecting each individual's age, and therefore provides the information needed to determine whether the identified consumer has an age within the preselected age range. In one embodiment, the consumer database is composed substantially of consumers having an age within the preselected age range, such that the identified consumer is the targeted consumer. In this instance, step 406 is essentially combined within step 404, since no further determination of whether the identified consumer is within the preselected age range is needed. In one embodiment, an individual is identified as a targeted consumer based on a measure of the individual's creditworthiness and whether the individual's social security number is issued during a time period when the individual's age is within a preselected age range of 18 years of age and over, whereby the targeted consumer is likely an immigrant or a resident alien.

The partial SSN identified in step 402 may be the first 5 digits of a SSN correlating with the predetermined SSN issue date range. As noted above, such a correlation is typically provided by a SSN issue date range database. More than one consumer may have a SSN with these identified first 5 digits. The search of the consumer database may therefore return a plurality of identified consumers, each of whom may be the targeted consumer in accordance with step 406. Moreover, it should be apparent that a plurality of partial SSNs may be identified in step 402 that correspond to SSNs issued by one or more U.S. states. Further, it may be desirable that only partial SSNs issued by particular U.S. state(s) be used to request the search of the consumer database. In this instance, the identified partial SSN would be screened for its first 3 digits so as to use those partial SSNs corresponding to the particular U.S. state.

In another embodiment of a process for identifying a targeted consumer, a consumer database (e.g., a credit bureau database) may provide a SSN issue date range for a potential targeted consumer. The potential targeted consumer is then identified as a targeted consumer based on the potential targeted consumer's SNN issue date range and age. In one embodiment, the potential targeted consumer is identified as a targeted consumer when the birth date of the potential targeted consumer precedes the potential targeted consumer's SSN issue date range by a preselected time period. If the preselected time period is at least 18 years, then the identified consumer is likely to be an immigrant or a resident alien just entering the United States market place. In another embodiment, if the potential targeted consumer's SSN issue date range includes a time period within the previous one to five years, and then the potential targeted consumer is considered likely to be at least 18 years of age is a targeted consumer, such as by virtue of being listed in a credit bureau database that is composed substantially of consumers ages 18 and over, then the potential targeted consumer is a targeted consumer. In another embodiment, a potential targeted consumer is identified to be a targeted consumer both when the birth date of the potential targeted consumer precedes the potential targeted consumer's SSN issue date range by a preselected time period of at least 18 years and when the potential targeted consumer is determined to be creditworthy.

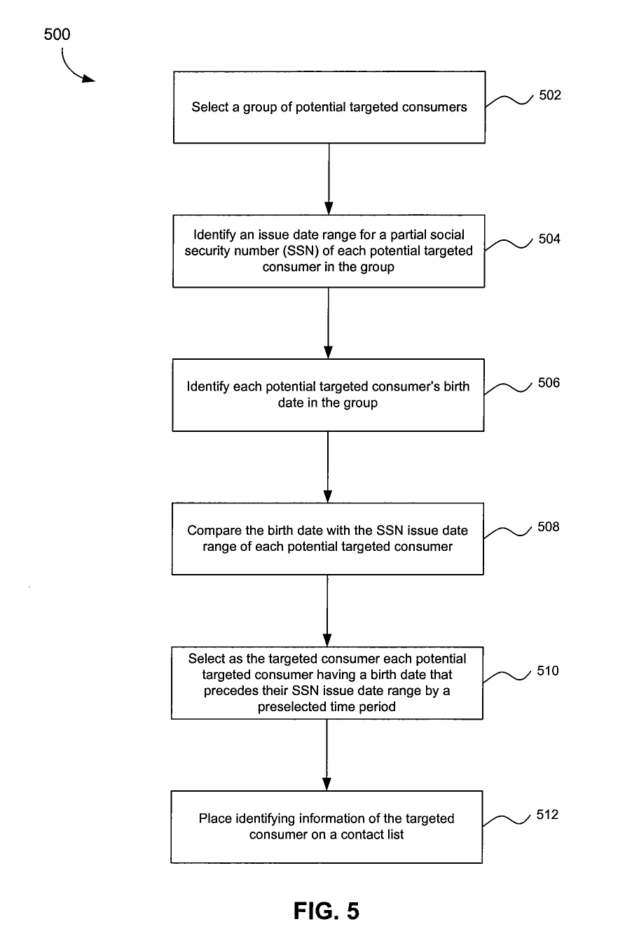

FIG. 5 shows a flow chart illustrating a process 500 for identifying targeted consumers, according to another embodiment of the present invention. In step 502, a group of potential targeted consumers are selected. The group of potential targeted consumers, may be, for example, individuals on a mailing list provided by a third party vendor, subscribers to a business newspaper/magazine, or individuals in a credit bureau database. In step 504, an issue date range for a partial SSN of each potential targeted consumer in the group is identified, and in step 506, the birth date of each potential targeted consumer in the group is identified. In step 508, the birth date is compared with the SSN date range for each potential targeted consumer. In step 510, each potential targeted consumer having a birth date that precedes the potential targeted consumer's SSN issue date range by a preselected time period is selected as the targeted consumer. The birth date may be an estimated birth date or a birth date range. In one embodiment, the preselected time period is at least 18 years. As such, the targeted consumers in this embodiment obtained SSNs during adulthood. In step 512, each targeted consumer is placed on a contact list, which may then be used, for example, in direct marketing efforts by a business for promotion of goods or services.

### IV. Example Implementations

The present invention (i.e., systems 100 and 200, and processes 300, 400, 500 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

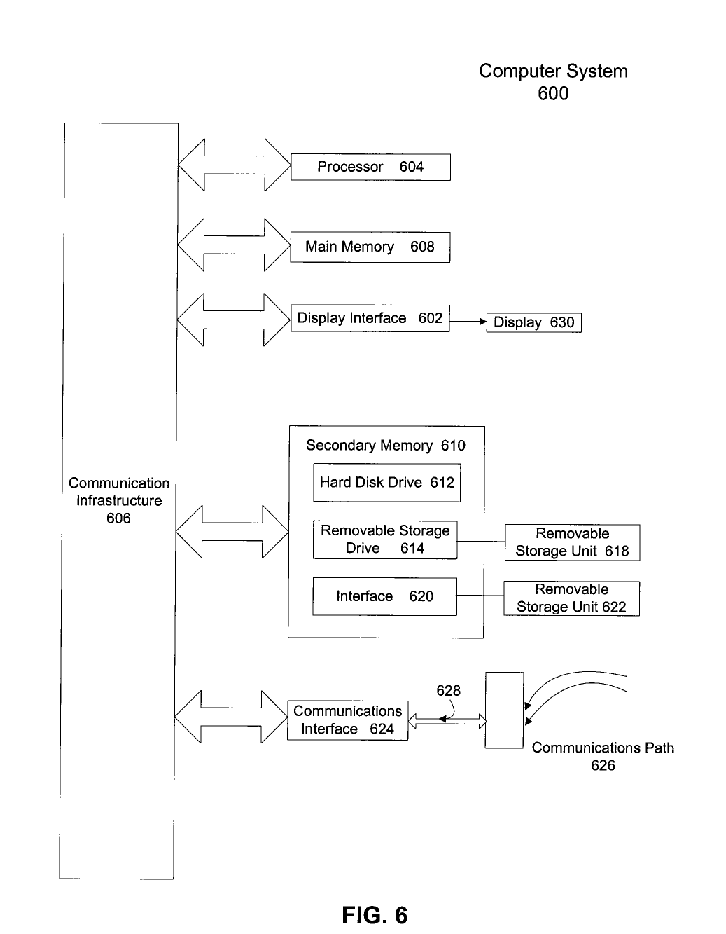

In fact, in one embodiment, the invention is directed toward one or more computer systems capable of carrying out the functionality described herein. An example of a computer system 600 is shown in FIG. 6.

The computer system 600 includes one or more processors, such as processor 604. The processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on the display unit 630.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618 represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for identifying a targeted consumer, comprising the steps of:
identifying an individual as a targeted consumer at least based on the individual's age being within a preselected age range and the individual's social security number being issued within a predetermined social security number (SSN) issue date range; and
if the individual is identified as a targeted consumer, then storing identifying information of the targeted consumer in a contact database.

2. The method of claim 1, wherein the individual is identified as the targeted consumer if the individual's social security number is issued during a time period when the individual's age is within the preselected age range.

3. The method of claim 2, wherein the identifying the individual as a targeted consumer step comprises:
identifying a partial SSN having an issue date range within the predetermined SSN issue date range;
using the identified partial SSN to request a search of a consumer database for identifying a consumer in the database that has a partial SSN that matches the identified partial SSN; and
determining if the identified consumer has an age within the preselected age range so as to be the targeted consumer.

4. The method of claim 3, wherein the partial SSN is the first five digits of a SSN and wherein the age of the identified consumer is an estimated age or age range.

5. The method of claim 2, wherein the identifying the individual as a targeted consumer step comprises:
identifying a partial SSN having an issue date range within the predetermined SSN issue date range; and
using the identified partial SSN to request a search of a consumer database for identifying a consumer in the database that has a partial SSN that matches the identified partial SSN, wherein the database is composed substantially of consumers having an age within the preselected age range such that the identified consumer is the targeted consumer.

6. The method of claim 5, wherein the partial SSN is the first five digits of a SSN, and wherein the consumer database is a credit bureau database.

7. The method of claim 1, wherein the predetermined SSN issue date range corresponds to a group of social security numbers issued in a given U.S. state within the previous year and having common fourth and fifth digits.

8. The method of claim 1, wherein the identifying the individual as a targeted consumer step includes identifying an individual as a targeted consumer based on a measure of the individual's creditworthiness and whether the individual's social security number was issued during a time period when the individual's age was within the preselected age range, wherein the preselected age range is 18 years of age and over.

9. The method of claim 2, wherein the preselected age range is 18 years of age and over.

10. A method for identifying a targeted consumer, comprising the steps of:
receiving a social security number (SSN) issue date range for a potential targeted consumer;
identifying the potential targeted consumer as a targeted consumer at least based on the age of the potential targeted consumer and the SSN issue date range of the potential targeted consumer; and
if the potential targeted consumer is identified as a targeted consumer, then storing identifying information of the targeted consumer in a contact database.

11. The method of claim 10, wherein the identifying step includes identifying a potential targeted consumer as a targeted consumer when the birth date of the potential targeted consumer precedes the SSN issue date range of the potential targeted consumer by a preselected time period, wherein the preselected time period is at least 18 years.

12. The method of claim 10, wherein the potential targeted consumer is a consumer listed in a credit bureau database that is composed substantially of consumers having an age of 18 years and over, wherein the identifying step includes identifying the potential targeted consumer as a targeted consumer when the SSN issue date range of the potential targeted consumer includes a time period within the previous year to the previous five years.

13. The method of claim 12, wherein the SSN issue date range of the potential targeted consumer is received from a credit bureau.

14. The method of claim 10, wherein the potential targeted consumer is identified to be a targeted consumer based on a measure of creditworthiness of the potential targeted consumer, the birth date of the potential targeted consumer, and the SSN issue date range of the potential targeted consumer.

15. The method of claim 14, wherein the identifying step includes identifying a potential targeted consumer to be a targeted consumer when the birth date of the potential targeted consumer precedes the SSN issue date range of the potential targeted consumer by a preselected time period of at least 18 years and when the potential targeted consumer is determined to be creditworthy.

16. The method of claim 14, wherein the potential targeted consumer's birth date is an actual birth date, an estimated birth date, or an estimated birth date range.

17. The method of claim 10, further comprising: providing marketing materials to the targeted consumer.

18. The method of claim 10, further comprising: accepting an application by the targeted consumer for issuance of a financial transaction instrument.

19. A system for identifying a targeted consumer, comprising:
a SSN issue date system that receives a result from a SSN matching system of at least one individual in a consumer database and a respective SSN issue date range, wherein the consumer database is composed substantially of consumers having an age within a preselected age range, and wherein the SSN issue date system identifies at least one individual that has a SSN issue date range within a preselected time period; and
a marketing database system that receives the at least one individual identified by the SSN issue date system and places identifying information of at least one the at least one identified individuals in a marketing database.

20. The system of claim 19, wherein the marketing database system selects at least one individual identified by the SSN issue date system based on a measure of creditworthiness, wherein only the selected individuals are placed in the marketing database.

21. The system of claim 19, wherein the preselected age range is ages 18 years and over, and the consumer database is a credit bureau database.

22. A system for identifying a targeted consumer, comprising:
a partial SSN system that identifies a partial SSN issued during a preselected time period;
a SSN matching system that identifies at least one individual in a consumer database that matches the partial SSN identified by the partial SSN system and produces a comparison result; and
a marketing database system that receives the comparison result from the SSN matching system and places identifying information of the at least one individual in a marketing database.

23. The system of claim 22, wherein the preselected time period is the previous two years.

24. The system of claim 22, wherein the consumer database is composed substantially of consumers having an age within a preselected age range.

25. The system of claim 24, wherein the preselected age range is 18 years of age and over.
